(19) United States
(12) Patent Application Publication
(10) Pub. No.: US 2013/0210610 A1
(43) Pub. Date: Aug. 15, 2013

(54) METHOD OF PREPARING PRECIOUS METAL NITRIDE NANOPARTICLE COMPOSITIONS

(71) Applicants: Gabriel M. VEITH, Knoxville, TN (US); Nancy J. DUDNEY, Knoxville, TN (US)

(72) Inventors: Gabriel M. VEITH, Knoxville, TN (US); Nancy J. DUDNEY, Knoxville, TN (US)

(73) Assignee: UT-BATTELLE, LLC, Oak Ridge, TN (US)

(21) Appl. No.: 13/372,956

(22) Filed: Feb. 14, 2012

(51) Int. Cl. B01J 27/24; B01J 37/34; B82Y 40/00; B82Y 30/00

(52) U.S. Cl. 502/5; 502/200; 502/180; 977/896; 977/773

(57) ABSTRACT

A method of preparing a precious metal nitride nanoparticle composition, includes the step of ionizing nitrogen in the gas phase to create an active nitrogen species as a plasma. An atomic metal species of the precious metal is provided in the gas phase. The active nitrogen species in the gas phase is contacted with the atomic metal species of the precious metal in the gas phase to form a precious metal nitride. The precious metal nitride is deposited on the support. Precious metal nanoparticle compositions are also disclosed.

### STATEMENT REGARDING FEDERALLY SPONSORED RESEARCH

This invention was made with government support under contract No. DE-AC05-00OR22725 awarded by the U.S. Department of Energy. The government has certain rights in this invention.

### FIELD OF THE INVENTION

This invention relates generally to nanoparticles, and more particularly to precious metal nanoparticles and methods of making precious metal nanoparticle compositions.

### BACKGROUND OF THE INVENTION

Precious metals such as silver, platinum, ruthenium, rhodium, palladium, osmium, and iridium have wide industrial and research utility as catalysts for a number of chemical reactions. Precious metal nanoparticles having a diameter of less than 5 nm are especially desirable as the surface area of smaller particles improves the catalytic activity of the particles. Most grown precious metal nanoparticles are metallic metal particles, which are expensive as only the metallic surface participates in the catalysis. The increasing cost of precious metal commodities has resulted in research to develop catalytic particles which have a lower cost.

Sputtering is a well known technique used to deposit thin films of a material onto a substrate wherein a neutral gas is used to create a gaseous plasma. Ions from this plasma are accelerated into a target material that is to be deposited on the substrate. Ions from the plasma are attracted to the negatively charged target and collide with the target and eject target atoms as individual atoms, clusters of atoms or molecules. The ejected target material contacts the substrate and is deposited on the substrate as a thin film.

Magnetron sputtering uses a magnetic field in the vicinity of the cathode to trap the free electrons in the magnetic field directly above the target surface. The trapped electrons improve ionization in the plasma and thus the rate at which the target material is ejected and subsequently deposited onto the substrate. Also, the trapped electrons do not bombard the substrate which can result in heat generation and damage.

### SUMMARY OF THE INVENTION

A method of preparing a precious metal nitride nanoparticle compositions includes the steps of ionizing nitrogen in the gas phase to create an active nitrogen species in the gas phase; providing atomic metal species of the precious metal in the gas phase; contacting the active nitrogen species with the atomic metal species of the precious metal in the gas phase to form a precious metal nitride; and, depositing the nitride on a support. The steps of ionizing nitrogen and providing atomic species of the precious metal in the gas phase can be provided by the formation of a plasma.

The precious metal nanoparticle can comprise at least one metal selected from the group consisting of silver, platinum, ruthenium, rhodium, palladium, osmium, iridium, and gold.

The support can be carbon, an oxide of a transition metal, an oxide of a rare earth metal, a nitride, a carbide, a boride, a sulfide, and/or a metal. The support can be a particle, a single crystal, a polycrystalline sheet, or a sintered plate.

The gas phase metal species can be created by a method selected from the group consisting of magnetron sputtering, reactive ion etching, arc discharge sputtering, plasma enhanced chemical vapor deposition, ion implanting, plasma etching, and cathodic arc discharge.

The nitrogen can comprise at least one of N₂ and NH₃. The metal nitride can have nitrogen to metal stoichiometric ratios between 1:8 and 8:1 nitrogen:metal. The nanoparticles that are formed on the support can be between 1-100 nm in diameter. The nanoparticles can be between 1-50 nm in diameter. The nanoparticles can be between 1-5 nm in diameter.

The support can be moved during the deposition process to cover all external surfaces. The support can be fluidized or stirred or mixed by tumbling, or gas, or vibration, or other mechanical means or fully fluidized by gas flow.

A precious metal nitride nanoparticle comprises a support and a precious metal nitride adherently grown on the support. The precious metal can be at least one metal selected from the group consisting of silver, platinum, ruthenium, rhodium, palladium, osmium, iridium, and gold. The support can be carbon, an oxide of a transition metal, an oxide of a rare earth metal, a nitride, a sulfide, a metal, and/or a carbide. The support can be a single crystal, a polycrystalline sheet, or a sintered plate.

The metal nitride can have nitrogen to metal stoichiometric ratios between 1:8 and 8:1 nitrogen:metal. The precious metal nitride nanoparticle can be between 1-100 nm in diameter, or between 1-50 nm in diameter, or between 1-5 nm in diameter.

### BRIEF DESCRIPTION OF THE DRAWINGS

There are shown in the drawings embodiments that are presently preferred it being understood that the invention is not limited to the arrangements and instrumentalities shown, wherein:

FIG. 1 is x-ray photoelectron spectroscopy (XPS) data for (top) PtNₓ deposited on carbon XC72 in N₂ atmosphere; and (bottom) Pt deposited on carbon in inert Argon atmosphere.

FIG. 2 is XPS data for PtNₓ grown on carbon black.

FIG. 3 is aberration corrected scanning transmission electron microscopy (STEM) image for PtNₓ nanoparticles grown on carbon black. The bright white spots are the PtNₓ clusters.

FIG. 4 is a STEM image for PtNₓ nanoparticles grown on carbon black.

FIG. 5 is a STEM image for PtNₓ nanoparticles grown on carbon black.

FIG. 6 is XPS data for (top) PdNₓ deposited on carbon XC72 in N₂ atmosphere; and (bottom) Pd deposited on carbon in inert Argon atmosphere.

FIG. 7 is XPS data for PdNₓ grown on carbon black.

FIG. 8 is a STEM image for PdNₓ nanoparticles grown on carbon black.

FIG. 9 is a STEM image for PdNₓ nanoparticles grown on carbon black.

FIG. 10 is a STEM image of PtNₓ grown on TiO₂.

FIG. 11 is a STEM image of PtNₓ grown on TiO₂.

FIG. 12 is a STEM image of PtNₓ grown on TiO₂.

### DETAILED DESCRIPTION OF THE INVENTION

A method of preparing a precious metal nitride nanoparticle composition includes the step of ionizing nitrogen in the gas phase to create an active nitrogen species in the gas phase. An atomic metal species of the precious metal is provided in the gas phase. In one aspect, the atomic metal species of the precious metal is provided in the gas phase by subjecting a target of the precious metal to ions from a plasma. The active nitrogen species in the gas phase is contacted with the atomic metal species of the precious metal in the gas phase where they react together to form a precious metal nitride. The precious metal nitride is deposited on a support.

The precious metal can comprise at least one metal selected from the group consisting of silver, platinum, ruthenium, rhodium, palladium, osmium, iridium, and gold.

The support material must be vacuum stable and should be nonreactive with the plasma. The support should have a high surface area, such as between 1 m²/g and 2000 m²/g and not dependent on porosity, tamp density or morphology. The support can be in the form of particles or as sheets or other shapes. The support material can be a high surface area carbon. The support can be a high surface area transition metal or rare earth oxide, such as TiO₂, Al₂O₃, SiO₂, MgO, CeO₂, and Fe₂O₃. The support can be a high surface area carbide support such as TiC, WC, and NbC. The support can be a high surface area nitride such as TiN, WN, VN, Mo_{R}N, and C₃N₄. The support can also comprise sulfides, borides, and metals. The support can also comprise combinations and mixtures of support materials. An exemplary list of possible support materials not intended to be exhaustive is provided in Table 1.

TABLE 1
Types of supports (and mixtures of these).

| Carbon | Oxides | Nitrides | Carbides | Sulfides | Borides | Metals |
|---|---|---|---|---|---|---|
| Carbon black | MgO | | | | MgB₂ | |
| Graphite | Al₂O₃ | AlN | | | AlB₂ | |
| Graphene | SiO₂ | Si₃N₄ | SiC | | | |
| Carbon | Sc₂O₃ | | | | ScB | |
| nanotubes | | | | | | |
| Carbon | TiO₂ | TiN | TiC | TiS₂ | TiB₂ | Ti |
| nanohorns | | | | | | |
| fullerenes | V₂O₃, | VN | VC | VS₂ | VB₂ | V |
| | VO₂, | | | | | |
| | V₂O₅ | | | | | |
| | Cr₂O₃, | CrN | Cr₃C₂ | | | Cr |
| | CrO₆ | | | | | |
| | MnO, | MnN | | MnS₂ | | Mn |
| | Mn₂O₃, | | | | | |
| | Mn₃O₄, | | | | | |
| | MnO₂ | | | | | |
| | FeO, | Fe₃N, | | FeS₂ | | Fe |
| | Fe₂O₃ | Fe₂N | | | | |
| | CoO, | CoN | | | | Co |
| | Co₂O₃ | | | | | |
| | NiO, | | | | | Ni |
| | Ni₂O₃, | | | | | |
| | NiOOH | | | | | |
| | CuO, | Cu₃N | | | CuB₂ | Cu |
| | Cu₂O | | | | | |
| | ZnO | Zn₃N₂ | | ZnS | | Zn |
| | Y₂O₃ | | YN | | YB | |
| | ZrO₂ | ZrN | ZrC | | ZrB₂ | Zr |
| | NbO, | NbN | | | NbB, | Nb |
| | Nb₂O₃, | | | | Nb₂B | |
| | Nb₂O₅ | | | | | |
| | MoO₂, | Mo₂N, | Mo₂C | MoS₂ | Mo₂B, | Mo |
| | Mo₂O₅ | MoN | | | MoB | |
| | RuO₂, | | | | | Ru |
| | RuO₃ | | | | | |
| | CaO | | | | | |
| | SrO | | | | | |
| | BaO | | | | | |
| | La₂O₃ | | | | LaB₆ | |
| | HfO₂ | | HfC | | HfB₂ | Hf |
| | Ta₂O₅ | | | | TaB | Ta |
| | WO₂, | WN, | WC | WS₂ | WB, | W |
| | WO₃ | W₂N | | | WB₂ | |
| | ReO₃ | | | | ReB₂ | Re |
| | Tl₂O₃ | | | | | Tl |
| | Bi₂O₃ | | | | | Bi |
| | Ce₂O₃, | | | | CeB₆ | |
| | CeO₂ | | | | | |
| | Pr₂O₃ | | | | | |
| | Nd₂O₃ | | | | | |
| | Sm₂O₃ | | | | | |
| | Eu₂O₃ | | | | | |
| | Gd₂O₃ | | | | | |
| | Tb₂O₃ | | | | | |
| | Dy₂O₃ | | | | | |
| | HO₂O₃ | | | | | |
| | Er₂O₃ | | | | | |
| | Tm₂O₃ | | | | | |
| | Yb₂O₃ | | | | | |
| | Lu₂O₃ | | | | | |
| | ThO₂ | | | | | |
| | UO₂ | | | | UB | |
| | | C₃N₄ | | | | |
| | B₂O₃ | BN | | | | B |
| | | GaN | | | | |
| | | | | CdS | | |

If provided as support particles, the particles can have a diameter of between about 5 nm and 0.1 mm. The metal nitride if grown on a support particle will form metal-nitride nanoparticles when the concentration of metal is less than what is required to form a monolayer coating on the exterior of the support particle. If deposited on a flat support the metal nitride will itself form the nanoparticle on the larger support if the concentration of the metal is less than what is required to form a monolayer coating on the exterior of the flat support as estimated from the geometric surface area.

The support could be a low specific surface area polycrystalline sheet of the above phases, such as a single crystal or sintered plate. The support when provided as a sheet or plate is preferably flat, from atomically flat to a roughness of 10 μm/mm. When formed on a sheet or plate support, less than a complete layer of the nitride is placed onto the sheet or plate so as to form discrete nanoparticles or islands of the nitride on the support. The nanoparticles will be formed due to incomplete film growth. The support could be single crystal of the above phases. A single crystal support can be moved under the reactive magnetron sputtering source for times less than required to make continuous film resulting in formation of nanoparticles.

Any suitable method for creating the plasma can be used. Types of plasma based methods that could be used to prepare gas phase atomic metal species, without limitation, include magnetron sputtering (both dc and rf), reactive ion etching, arc discharge sputtering, plasma enhanced chemical vapor deposition, ion implanting, plasma etching, and cathodic arc discharge.

The nitrogen can be provided as N₂ or as ammonia. The N₂ and NH₃ can be mixed with inert gases like Ar, Kr, He, Ne, and Xe but not oxidative gases like O₂, NO, O₃, NO₂, N₂O. Flow rates of gases can be adjusted to be between 1 standard cubic centimeter per minute (sccm) and 100 liters per minute depending on production needs and the size of the deposition chamber.

The nitrogen is ionized in the gas phase to create an active nitrogen species as a plasma or as a component of the plasma. Ions from the plasma strike a target of the precious metal to generate gas phase atomic metal species. The active nitrogen species is contacted with the atomic metal species of the precious metal in the gas phase. The atomic metal species reacts with nitrogen in the gas phase and is deposited on the substrate as a nitride. The temperature in the reaction vessel can be between 77 K and 500 K. Vacuum ranges can be below 1 torr to ×10⁻¹⁰ torr. The substrate distance and power depend on deposition chamber unique to each chamber.

The support particles can be fluidized or stirred during the process to expose all external surfaces to the deposition flux. The support particles can be mixed by tumbling, or gas, or vibration, or other mechanical means or fully fluidized by gas flow. The ejected metal atoms react in the gas phase and condense on the substrate surface. When the amount of material deposited is less than a monolayer nanoparticles of metal nitride are grown on the support.

The invention can be utilized to coat supports of various shapes and sizes, including powders, plates and other shapes. The surface area of the surface can be measured by any suitable method such as, but not limited to, nitrogen physisorption. This measurement can be used to determine surface area as a function of pore size. The surface area from microporosity and mesoporosity of the samples can be excluded since the depositied species won't go into pores. The resulting deposited species should be less material than would be required to coat the available external surface of the support with a monolayer of material. More than a monolayer will form a continuous film. The amount of material deposited depends on many factors including the power applied, gas pressures, distance, gas mixtures and deposition chamber.

The metal nitride can have nitrogen to metal stoichiometric ratios between 1:8 and 8:1 nitrogen:metal. The metal nitride can form a continuous coating over the surface of the support, or can be distributed as particles adhered to the surface of the support in a discontinuous fashion. The precious metal nanoparticle is adherently grown on the high surface area support. The precious metal nanoparticles that are formed on the support can be 1-100 nm in diameter, or 1-50 nm, and can be smaller than 10, 9, 8, 7, 6, 5, 4, 3, 2, or 1 nm in diameter. The amount of metal nitride that is deposited on the support can vary. The metal nitride in one aspect can be 0.1%, 1%, 10%, 20%, 30%, 40%, 50% or 60% of the total weight of metal nitride and support, as well as any percentage there between.

### EXAMPLE 1

### PtNₓ on Carbon Black

2.01 grams of XC72 carbon black (Vulcan®, Cabot Corp., Alpharetta Ga.) was tumbled in a rotary mixer below sputtering source. An applied power of 22 watts was applied to the target in a steady flow of 20 sccm (standard cubic centimeters per minute) N₂ gas at an applied pressure of 26 mtorr. After 1 hour 0.28 wt % Pt was deposited on the carbon black powder as estimated using inductively coupled plasma optical emission spectroscopy (ICP-OES). Nitrogen analysis using the Kjeldahl procedure estimated that the as deposited samples contained 0.119 wt % Nitrogen. Together this indicates a N:Pt atomic ratio of 5.9:1 (using molecular weights 14.0 gram/mole for Nitrogen and 195 grams/mole for Pt). Elemental analysis data from X-ray photoelectron spectroscopy (XPS) estimated a N:Pt ratio of 5.4:1 in good agreement with the elemental analysis data from the ICP-OES and Kjeldahl methods.

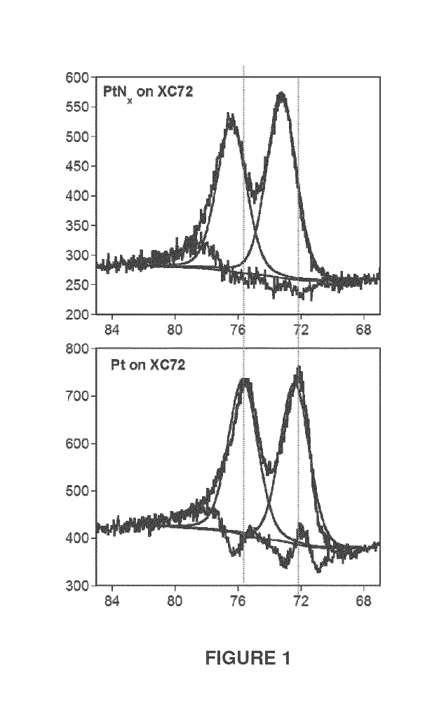

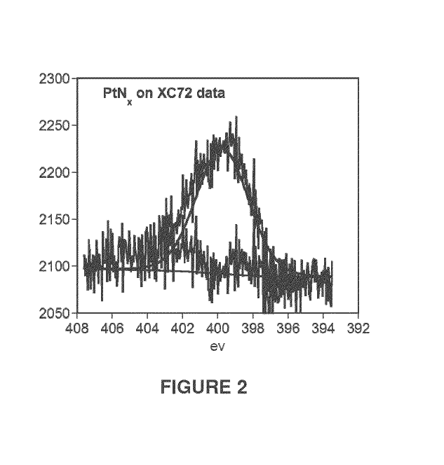

Platinum XPS measurements reveal the oxidation of Pt to Pt⁺ with incorporation of Nitrogen FIG. 1 (top) compared to a neutral Pt when deposited in argon, FIG. 1 (bottom). FIG. 2 shows N1s data collected for PtNₓ deposited on Carbon showing a single N peak at 399 eV consistent with metal nitride formation.

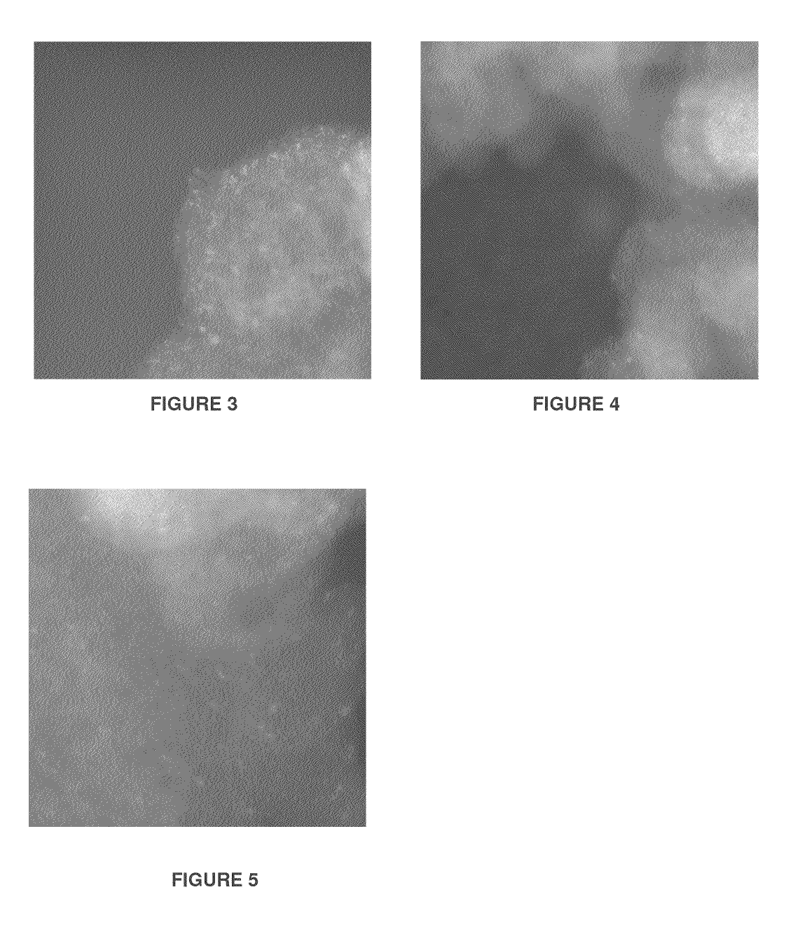

FIGS. 3-5 show aberration corrected scanning transmission electron microscopy (STEM) images for PtNₓ nanoparticles grown on carbon black. The bright white spots are the PtNₓ clusters.

### EXAMPLE 2

### PdNₓ on Carbon Black

2.01 grams of XC72 carbon black (Vulcan®, Cabot Corp., Alpharetta Ga.) was tumbled in a rotary mixer below a sputtering source. An applied power of 24 watts was applied to the target in a steady flow of 20 sccm (standard cubic centimeters per minute) N₂ gas N₂ gas at an applied pressure of 26 mtorr. After 2 hour 0.18 wt % Pd was deposited on the carbon black powder as estimated using inductively coupled plasma optical emission spectroscopy (ICP-OES). Nitrogen analysis using the Kjeldahl procedure estimated that the as deposited samples contained 0.159 wt % Nitrogen. Together this indicates a N:Pd atomic ratio of 6.7:1 (using molecular weights 14.0 gram/mole for Nitrogen and 106.42 grams/mole for Pd). Elemental analysis data from X-ray photoelectron spectroscopy (XPS) estimated a N:Pd ratio of 6.4:1 in good agreement with the elemental analysis data from the ICP-OES and Kjeldahl methods.

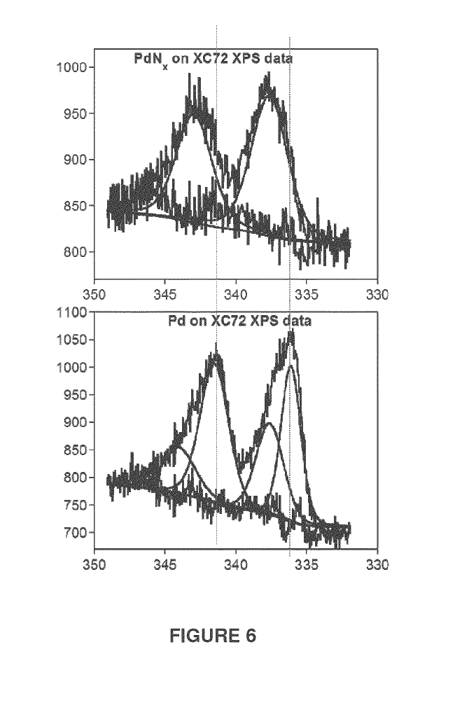

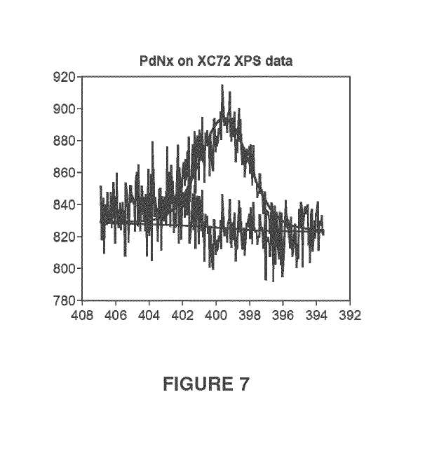

Palladium XPS measurements reveal the oxidation of Pd to Pd⁺ with incorporation of Nitrogen FIG. 6 (top) compared to a neutral Pd when deposited in argon, FIG. 6 (bottom). FIG. 7 shows N1s data collected for PdNₓ deposited on Carbon showing a single N peak at 399 eV consistent with metal nitride formation.

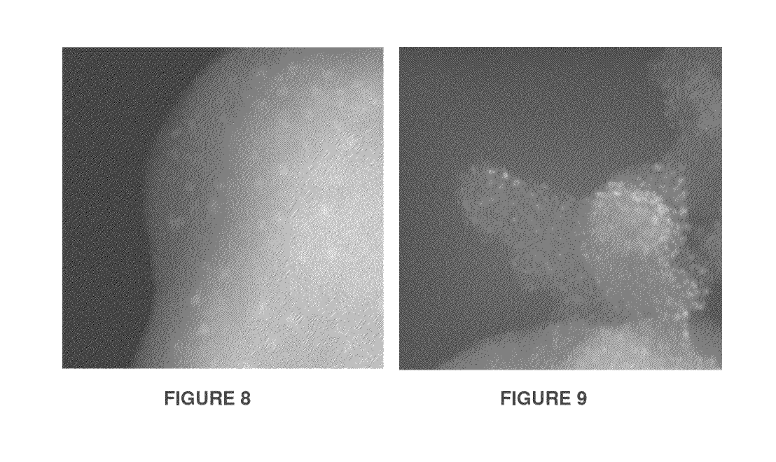

FIGS. 8-9 show aberration corrected Scanning transmission electron microscopy images for PdNₓ nanoparticles grown on carbon black. The bright white spots are the PdNₓ clusters.

### Example 3

### PtNₓ on TiO₂

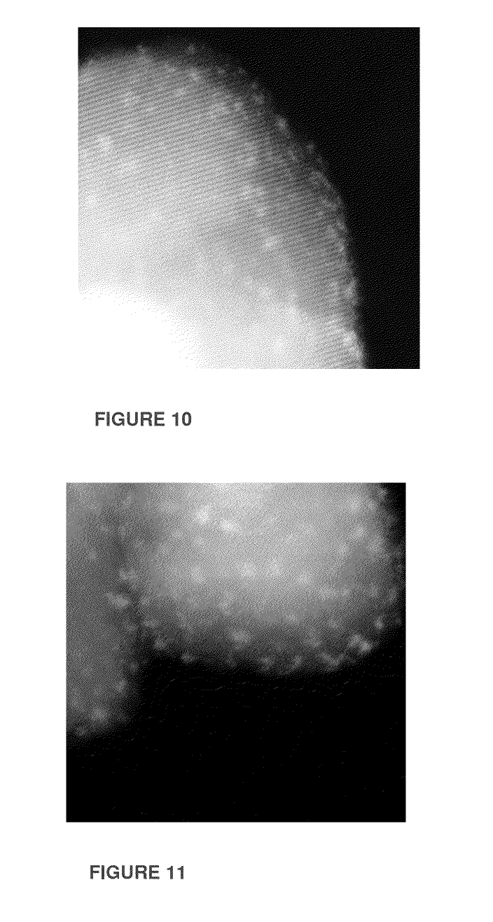

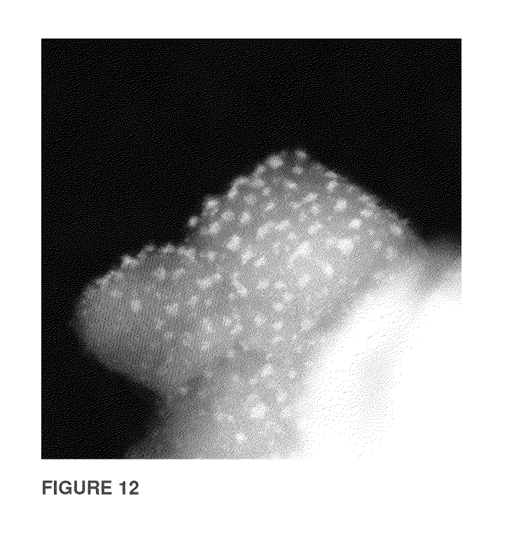

1.0 grams of TiO₂ (Degussa Brand—P25) was tumbled in a rotary mixer below sputtering source. An applied power of 22 watts was applied to the target in a steady flow of 20 sccm (standard cubic centimeters per minute) N₂ gas at an applied pressure of 26 mtorr. After 1 hour 0.31 wt % Pt was deposited on the carbon black powder as estimated using inductively coupled plasma optical emission spectroscopy (ICP-OES). Elemental analysis data from X-ray photoelectron spectroscopy (XPS) estimated a N:Pt ratio of 3:1. FIGS. 10-12 show aberration corrected Scanning transmission electron microscopy images for PtNₓ nanoparticles grown on carbon black. The bright white spots are the PtNx clusters.

The metal-nitride nanoparticle compositions of the invention could be of use in modifying catalytic metal properties or diluting the concentration of metal required for a catalyst or stabilize the metal particle against coarsening. Catalytic nanoparticles according to the invention could also have utility in a variety of devices such as magnetic storage media and batteries

The foregoing description of the preferred embodiments of the invention has been presented for purposes of illustration. The invention is not limited to the embodiments disclosed. Modifications and variations to the disclosed embodiments are possible and within the scope of the invention.

We claim:

1. A method of preparing a precious metal nitride nanoparticle composition, comprising the steps of:
ionizing nitrogen in the gas phase to create an active nitrogen species in the gas phase;
providing atomic metal species of the precious metal in the gas phase;
contacting the active nitrogen species with the atomic metal species of the precious metal in the gas phase to form a precious metal nitride; and,
depositing the nitride on a support.

2. The method of claim 1, wherein the steps of ionizing nitrogen and providing atomic species of the precious metal in the gas phase are provided by the formation of a plasma.

3. The method of claim 1, wherein the precious metal nanoparticle comprises at least one metal selected from the group consisting of silver, platinum, ruthenium, rhodium, palladium, osmium, iridium, and gold.

4. The method of claim 1, wherein the support is at least one selected from the group consisting of carbon, an oxide of a transition metal, an oxide of a rare earth metal, a nitride, a carbide, a boride, and a sulfide.

5. The method of claim 1, wherein the support is a metal.

6. The method of claim 1, wherein the support is a single crystal.

7. The method of claim 1, wherein the support is a polycrystalline sheet.

8. The method of claim 1, wherein the support is a sintered plate.

9. The method of claim 1, wherein the gas phase metal species is created by a method selected from the group consisting of magnetron sputtering, reactive ion etching, arc discharge sputtering, plasma enhanced chemical vapor deposition, ion implanting, plasma etching, and cathodic arc discharge.

10. The method of claim 1 wherein the nitrogen comprises at least one of N₂ and NH₃.

11. The method of claim 1, wherein metal nitride can have nitrogen to metal stoichiometric ratios between 1:8 and 8:1 nitrogen:metal.

12. The method of claim 1, wherein the nanoparticles are between 1-100 nm in diameter.

13. The method of claim 1, wherein the nanoparticles are between 1-50 nm in diameter.

14. The method of claim 1, wherein the nanoparticles are between 1-5 nm in diameter.

15. The method of claim 1, wherein the support is moved during the deposition process to cover all external surfaces.

16. The method of claim 15 wherein the support is moved by at least one selected from the group consisting of fluidizing, stirring, mixing, tumbling, gas flow, and vibration.

17. The method of claim 1, wherein the amount of nitride deposited on the support is less than the amount required to form a complete monolayer.

18. A precious metal nitride nanoparticle composition comprising a support and a precious metal nitride nanoparticle adherently grown on the support.

19. The precious metal nitride nanoparticle composition of claim 18, wherein the precious metal nanoparticle comprises at least one metal selected from the group consisting of silver, platinum, ruthenium, rhodium, palladium, osmium, iridium, and gold.

20. The precious metal nitride nanoparticle composition of claim 18, wherein the support is at least one selected from the group consisting of carbon, an oxide of a transition metal, an oxide of a rare earth metal, a nitride, a carbide, a boride, and a sulfide.

21. The precious metal nitride nanoparticle composition of claim 18, wherein the support is a metal.

22. The precious metal nitride nanoparticle composition of claim 18, wherein the support is a single crystal.

23. The precious metal nitride nanoparticle composition of claim 18, wherein the support is a polycrystalline sheet.

24. The precious metal nitride nanoparticle composition of claim 18, wherein the support is a sintered plate.

25. The precious metal nitride nanoparticle composition of claim 18, wherein metal nitride can have nitrogen to metal stoichiometric ratios between 1:8 and 8:1 nitrogen:metal.

26. The precious metal nitride nanoparticle composition of claim 18, wherein the nanoparticles are between 1-100 nm in diameter.

27. The precious metal nitride nanoparticle composition of claim 18, wherein the nanoparticles are between 1-50 nm in diameter.

28. The precious metal nitride nanoparticle composition of claim 18, wherein the nanoparticles are between 1-5 nm in diameter.
